(19) United States
(12) Patent Application Publication
(10) Pub. No.: US 2014/0028635 A1
(43) Pub. Date: Jan. 30, 2014

(54) MODULAR STYLUS DEVICE

(71) Applicant: Christoph Horst KRAH, Los Altos, CA (US)

(72) Inventor: Christoph Horst KRAH, Los Altos, CA (US)

(21) Appl. No.: 13/560,960

(22) Filed: Jul. 27, 2012

(51) Int. Cl. G06F 3/033

(52) U.S. Cl. 345/179

(57) ABSTRACT

Modular styluses having a base module an expansion module are disclosed. The base module can include a stylus tip, a stylus stimulation signal circuit capable of generating a stimulation signal, a processor for controlling the stylus stimulation signal circuit, and a connection interface for selectively connecting the base module to an expansion module. The expansion module can include a power source for providing power to the stylus stimulation signal circuit and the processor. The expansion module can also include one or more of a power source, camera, audio recorder, communication circuit, gyroscope, accelerometer, laser pointer, projector, or the like. The projector can be used to display an image on a surface and to allow a user to edit a document by moving the stylus across the projected image.

### FIELD

This relates generally to touch sensitive devices and, more specifically, to a modular stylus for use with touch sensitive devices.

### BACKGROUND

Touch sensitive devices have become popular as input devices to computing systems due to their ease and versatility of operation as well as their declining price. A touch sensitive device can include a touch sensor panel, which can be a clear panel with a touch sensitive surface, and a display device, such as a liquid crystal display (LCD), that can be positioned partially or fully behind the panel or integrated with the panel so that the touch sensitive surface can cover at least a portion of the viewable area of the display device. The touch sensitive device can allow a user to perform various functions by touching the touch sensor panel using a finger, stylus or other object at a location often dictated by a user interface (UI) being displayed by the display device. In general, the touch sensitive device can recognize a touch event and the position of the touch event on the touch sensor panel, and the computing system can then interpret the touch event in accordance with the display appearing at the time of the touch event, and thereafter can perform one or more actions based on the touch event.

As touch sensing technology continues to improve, touch sensitive devices are increasingly being used to compose and mark-up electronic documents. In particular, styluses have become popular input devices as they emulate the feel of traditional writing instruments. However, while touch technology has greatly improved over the past few years, little has been done to improve the stylus itself. Most conventional styluses simply include a tip configured to interact with the touch sensitive device and an optional pen insert for writing on paper. As a result, conventional styluses suffer from poor performance and offer limited functionality.

### SUMMARY

Modular styluses having a base module and one or more expansion modules are disclosed. The base module can include a stylus tip, a stylus stimulation signal circuit capable of generating a stimulation signal, a processor for controlling the stylus stimulation signal circuit, and a connection interface for selectively connecting the base module to one of the expansion modules. Each of the expansion modules can include one or more of a power source, camera, audio recorder, communication circuit, gyroscope, accelerometer, laser pointer, projector, or the like. The projector can be used to display an image on a surface and to allow a user to edit a document by moving the stylus across the projected image. Alternatively, the projector can be included within the base module.

### BRIEF DESCRIPTION OF THE DRAWINGS

FIG. 1 illustrates an exemplary touch sensor that can be used with a touch sensitive device according to various embodiments.

FIG. 2 illustrates a block diagram of an exemplary modular stylus according to various embodiments.

FIG. 3 illustrates a block diagram of an exemplary base module according to various embodiments.

FIG. 4 illustrates a block diagram of another exemplary base module according to various embodiments.

FIG. 5 illustrates a block diagram of an exemplary expansion module according to various embodiments.

FIG. 6 illustrates a block diagram of another exemplary expansion module according to various embodiments.

FIG. 7 illustrates a block diagram of another exemplary expansion module according to various embodiments.

FIG. 8 illustrates a block diagram of another exemplary expansion module according to various embodiments.

FIG. 9 illustrates a block diagram of another exemplary expansion module according to various embodiments.

FIG. 10 illustrates a block diagram of an exemplary expansion module having projection and/or imaging capabilities.

FIG. 11 illustrates the operation of an exemplary modular stylus having a projector in the base module.

FIG. 12 illustrates the operation of an exemplary modular stylus having a projector in the expansion module.

FIG. 13 illustrates the operation of the exemplary modular styluses of FIGS. 12 and 13.

FIG. 14 illustrates a block diagram of an exemplary modular stylus according to various embodiments.

FIG. 15 illustrates a block diagram of another exemplary modular stylus according to various embodiments.

FIG. 16 illustrates an exemplary system that can be used with a modular stylus according to various embodiments.

FIG. 17 illustrates an exemplary personal device that includes a touch sensor and that can be used with a modular stylus according to various embodiments.

FIG. 18 illustrates another exemplary personal device that includes a touch sensor and that can be used with a modular stylus according to various embodiments.

### DETAILED DESCRIPTION

In the following description of example embodiments, reference is made to the accompanying drawings in which it is shown by way of illustration specific embodiments that can be practiced. It is to be understood that other embodiments can be used and structural changes can be made without departing from the scope of the various embodiments.

This relates to modular styluses having a base module and one or more expansion modules. The base module can include a stylus tip, a stylus stimulation signal circuit capable of generating a stimulation signal, a processor for controlling the stylus stimulation signal circuit, and a connection interface for selectively connecting the base module to one of the expansion modules. Each of the expansion modules can include one or more of a power source, camera, audio recorder, communication circuit, gyroscope, accelerometer, laser pointer, projector, or the like. The base module can be selectively coupled to any one of the expansion modules depending on the intended application.

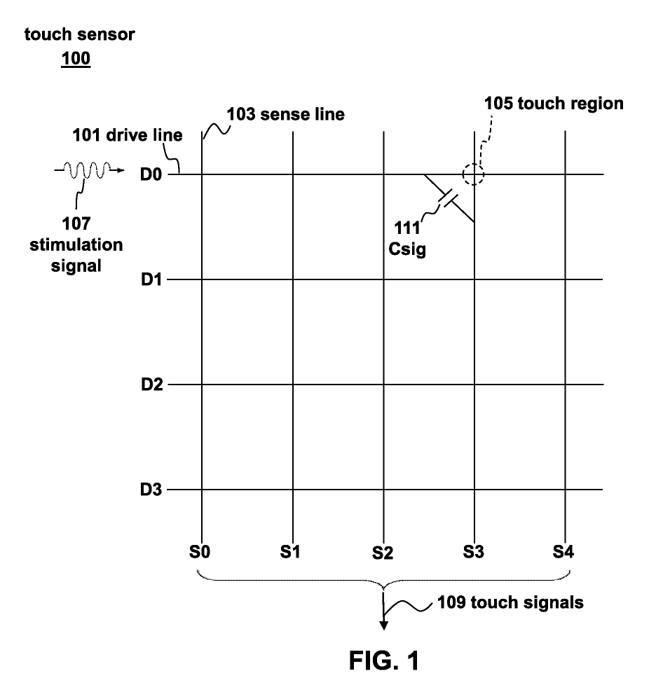

FIG. 1 illustrates touch sensor 100 that can be used to detect touch events on a touch sensitive device, such as a mobile phone, tablet, touchpad, portable computer, portable media player, or the like. Touch sensor 100 can include an array of touch regions or nodes 105 that can be formed at the crossing points between rows of drive lines 101 (D0-D3) and columns of sense lines 103 (S0-S4). Each touch region 105 can have an associated mutual capacitance Csig 111 formed between the crossing drive lines 101 and sense lines 103 when the drive lines are stimulated. The drive lines 101 can be stimulated by stimulation signals 107 provided by drive circuitry (not shown) and can include an alternating current (AC) waveform. The sense lines 103 can transmit touch signals 109 indicative of a touch at the touch sensor 100 to sense circuitry (not shown), which can include a sense amplifier for each sense line, or a fewer number of sense amplifiers that can be multiplexed to connect to a larger number of sense lines.

To sense a touch at the touch sensor 100, drive lines 101 can be stimulated by the stimulation signals 107 to capacitively couple with the crossing sense lines 103, thereby forming a capacitive path for coupling charge from the drive lines 101 to the sense lines 103. The crossing sense lines 103 can output touch signals 109, representing the coupled charge or current. When an object, such as a stylus, finger, etc., touches the touch sensor 100, the object can cause the capacitance Csig 111 to reduce by an amount ACsig at the touch location. This capacitance change ACsig can be caused by charge or current from the stimulated drive line 101 being shunted through the touching object to ground rather than being coupled to the crossing sense line 103 at the touch location. The touch signals 109 representative of the capacitance change ACsig can be transmitted by the sense lines 103 to the sense circuitry for processing. The touch signals 109 can indicate the touch region where the touch occurred and the amount of touch that occurred at that touch region location.

While the embodiment shown in FIG. 1 includes four drive lines 101 and five sense lines 103, it should be appreciated that touch sensor 100 can include any number of drive lines 101 and any number of sense lines 103 to form the desired number and pattern of touch regions 105. Additionally, while the drive lines 101 and sense lines 103 are shown in FIG. 1 in a crossing configuration, it should be appreciated that other configurations are also possible to form the desired touch region pattern. While FIG. 1 illustrates mutual capacitance touch sensing, other touch sensing technologies may also be used in conjunction with embodiments of the disclosure, such as self-capacitance touch sensing, resistive touch sensing, projection scan touch sensing, and the like. Furthermore, while various embodiments describe a sensed touch, it should be appreciated that the touch sensor 100 can also sense a hovering object and generate hover signals therefrom.

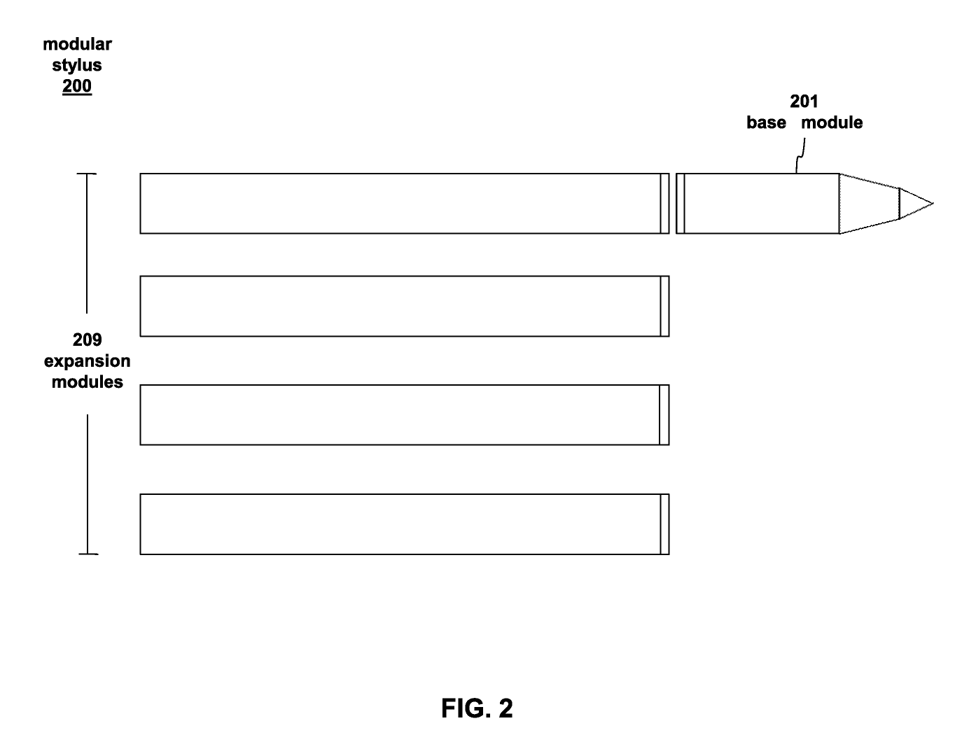

FIG. 2 illustrates a block diagram of an exemplary modular stylus 200 that can be used with a touch sensitive device, such as a mobile phone, touchpad, portable computer, or the like. Modular stylus 200 can generally include base module 201 and one or more expansion modules 209. As will be described in greater detail below, base module 201 can include components relating to the basic touch-detection functionality of modular stylus 200 and expansion modules 209 can include components for providing optional peripheral functionalities, such as audio/visual recording, laser pointing, motion detection, image projection, wireless communication, power supplying, and the like, that can be added to modular stylus 200. In this way, base module 201 can be selectively coupled to an expansion module 209 having the desired components and functionality for a given application. For example, base module 201 can be coupled to an expansion module 209 having a laser pointer when modular stylus 200 is being used in a presentation.

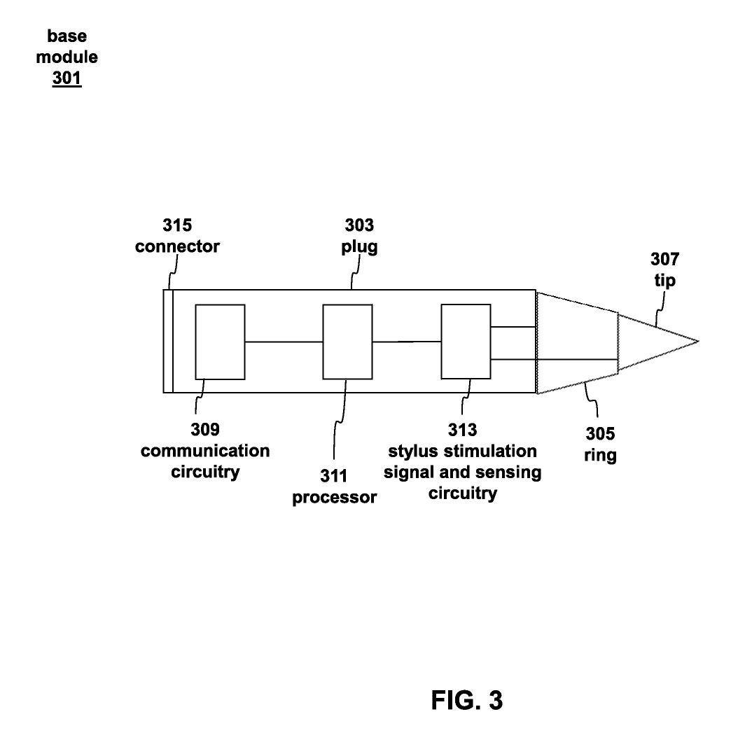

FIG. 3 illustrates a block diagram of an exemplary base module 301 that can be used as base module 201 of modular stylus 200. In this example, base module 301 includes plug 303, ring 305, and tip 307. As will be described in greater detail below, plug 303 can include components for generating a stylus stimulation signal that can be transmitted to a touch sensitive device through tip 307 or ring 305. Tip 307 can include a material capable of transmitting the stimulation signal from plug 303 to the touch sensitive device, such as a flexible conductor, a metal, a conductor wrapped by a non-conductor, a transparent insulating material (e.g., glass or plastic) coated with a transparent conductive material (e.g., indium tin oxide) if the tip is used for projection purposes, or the like. Tip 307 can be coupled to plug 303 by ring 305. Ring 305 can include a conductive material, such as a flexible conductor, a metal, a conductor wrapped by a non-conductor, a transparent insulating material (e.g. glass or plastic) coated with a transparent conductive material (e.g. indium tin oxide) if the tip is used for projection purposes, or the like. Ring 305 can serve other purposes, such as providing an alternative means for transmitting the stylus stimulation signal from the stylus to the touch sensitive device by serving as an antenna for a wireless module (e.g., RFID, Bluetooth, WI-FI, or the like). Both tip 307 and ring 305 can be segmented and each segment can be independently controlled according to the description above.

Plug 303 can further include stylus stimulation signal and sensing circuitry 313 that can be coupled to ring 305 and tip 307. Stylus stimulation signal and sensing circuitry 313 can be operable to generate and transmit a stylus stimulation signal to a touch sensitive device through tip 307 or ring 305 and to sense a signal from the touch sensitive device through tip 307 or ring 305. The stimulation signal can be similar to stimulation signal 107 and can be used by the touch sensitive device to determine the location of tip 307 on the touch sensitive surface of the device. The stylus stimulation signal can be at the same or a different frequency than the stimulation signals used within the touch sensitive device. Additionally or alternatively, the stylus stimulation signal can have the same or a different amplitude than the stimulation signals used within the touch sensitive device. Example stylus stimulation signal circuitry and stylus stimulation signals are described in “Stylus Device,” (Attorney Docket No. 10684-2047800) filed concurrently herewith. Furthermore, tip 307 can be used for stylus position detection, while ring 307 can be used to detect stylus tilt. Tip 307 and/or ring 305 can also be used to sense the stimulation signal at a given touch sensitive device in order to facilitate touch communications with the touch sensitive device.

Plug 303 can optionally include processor 311 coupled to control stylus stimulation signal and sensing circuitry 313 by selectively causing stylus stimulation signal and sensing circuitry 313 to generate a stylus stimulation signal or receive a signal from the touch sensitive device. Processor 311 can be configured to cause stylus stimulation signal and sensing circuitry 313 to generate the stimulation signal in response to an input from a user (e.g., an On/Off switch), detecting that a user is holding the stylus (e.g., using electrodes on the body of base module 301 or expansion module), detecting that tip 307 is in contact with a touch sensitive device (e.g., by detecting the touch sensitive device's stimulation signals through tip 307 or detecting pressure against tip 307), or the like. Alternatively, stylus stimulation signal and sensing circuitry 313 can include amplifiers, mixers, oscillators, and the like, or combinations thereof, configured to generate a stylus stimulation signal without processor 311.

Plug 303 can further optionally include communication circuitry 309 coupled to processor 311 for communicating with an expansion module. In some examples, communication circuitry 309 can include circuitry to support USB, Serial Peripheral Interface (SPI), I2C, RS232, or other data communication interfaces for transferring data between processor 311 and circuitry located in an attached expansion module.

Plug 303 can further include connector 315 for connecting base module 301 to an expansion module, such as expansion module 209. Connector 315 can include any type of connection interface, such as a threaded screw-type connector, plug-in connector, or the like. In some examples, connector 315 can include an interface (e.g., USB, SP1, I2C, RS232, and the like) that allows for the transfer of data and/or power between base module 301 and an attached expansion module.

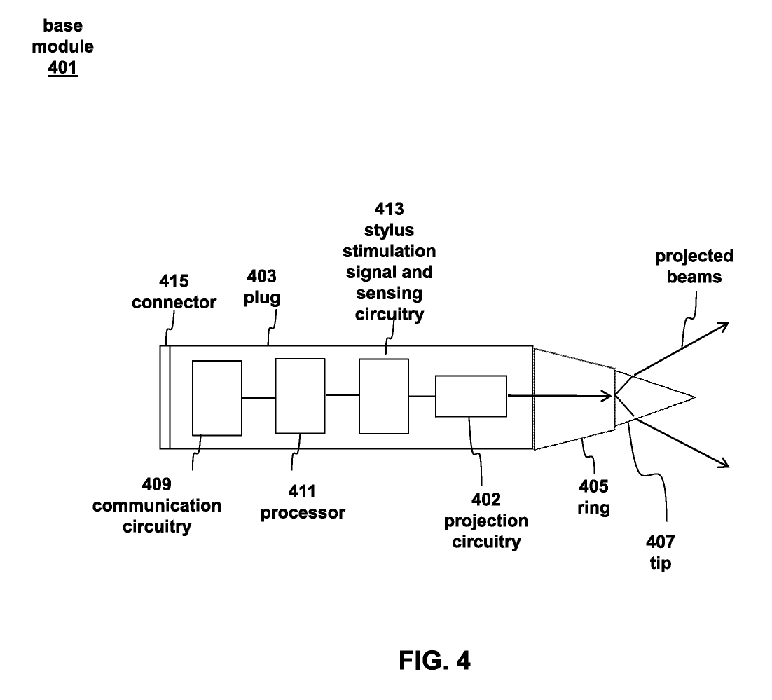

FIG. 4 illustrates yet another exemplary base module 401 operable to project an image through the tip 307. Base module 401 can include features similar to those of base module 301. For example, base module 401 can include processor 411 similar or identical to processor 311, stylus stimulation signal and sensing circuitry 413 similar or identical to stylus stimulation signal and sensing circuitry 313, communication circuitry 409 similar or identical to communication circuitry 309, connector 415 similar or identical to connector 315, and ring 405 similar or identical to ring 305. In the embodiment shown in FIG. 4, tip 407 can include a transparent lens and tip assembly having a suitable conductive coating. The coating can include indium tin oxide or any other suitable transparent material and can serve the purpose of transmitting the stimulation signal or receiving a signal from the touch sensitive device. Base module 401 can also include projection circuitry 402 operable to project an image through tip 407. The lens assembly of tip 407 can be operable to expand the beam from projection circuitry 402 to project it onto a surface. Projection circuitry 402 can include a projector or other suitable imaging device and suitable processing hardware or firmware to compensate for distortion incurred from projection circuitry 402 to the projection surface. In some examples, projection circuitry 402 can include a camera to image the projection surface for position detection by correlation (e.g., a technique similar to that used by optical mice) and/or to image an object (e.g., to provide scanner and/or camera functions).

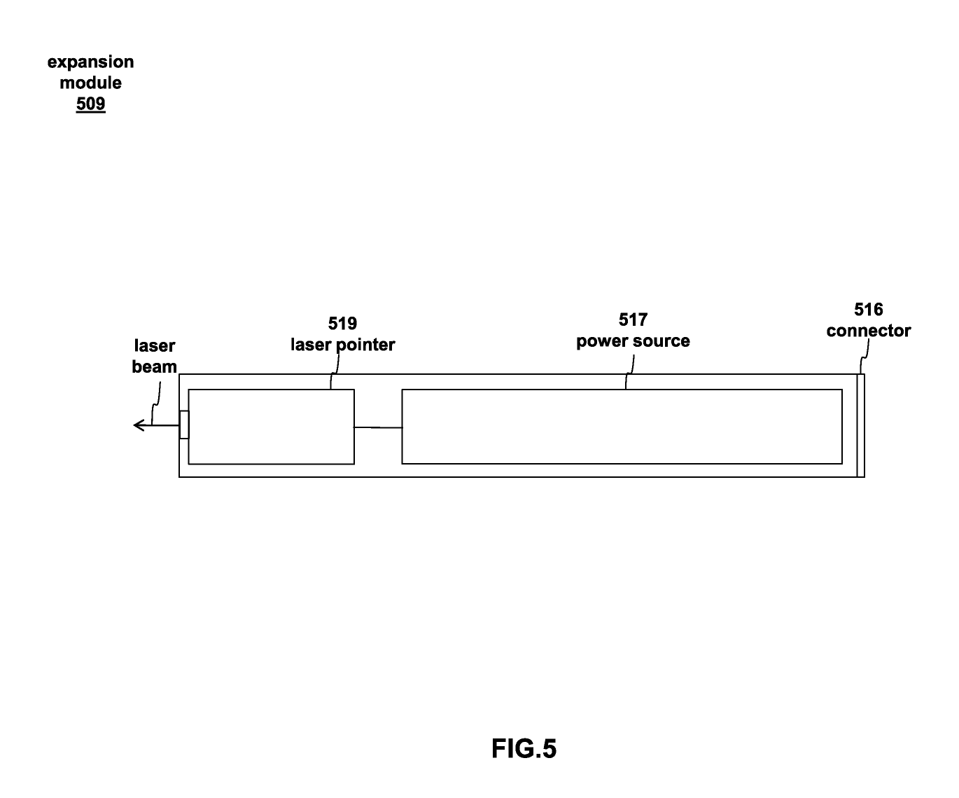

FIGS. 5-10 illustrate block diagrams of exemplary expansion modules that can be used as an expansion module 209 of modular stylus 200. As mentioned above, the expansion modules can include components that support additional functionality over the basic touch detection offered by the base unit. The specific components combined within the expansion module can be selected based on a desired use for the modular stylus. The expansion modules shown in FIGS. 5-10 are provided only as examples and it should be appreciated that other expansion modules having different combinations of components can be used.

FIG. 5 illustrates a block diagram of one exemplary expansion module 509 for providing a laser pointer functionality that can be used as an expansion module 209 of modular stylus 200. Expansion module 509 can include a connector 516 for connecting expansion module 509 to a base module, such as base module 201 or 301. Connector 516 can include a connection interface configured to engage the connection interface of the base module (e.g., connector 315). For example, connector 516 can include a threaded screw-type connector, plug-in connector, or the like. In some examples, connector 516 can include an interface (e.g., USB, SPI, I2C, RS232, and the like) that allows for the transfer of data and/or power between expansion module 509 and an attached base module.

Expansion module 509 can further include power source 517 for providing power to the components within expansion module 509 and/or the components within an attached base module. Power can be transferred from power source 517 to an attached base module via connector 516. In some examples, power source 517 can include non-rechargeable batteries, such as alkaline, zinc-carbon, and the like, inserted into the body of expansion module 509. In other examples, power source 517 can include a removable or non-removable rechargeable battery, such as lithium ion, lithium ion polymer, nickel cadmium, and the like, that can be charged via a physical wire connection (e.g., USB connection or other power input). In other examples, power source 517 can include a removable or non-removable rechargeable battery that can be charged wirelessly. In these examples, power source 517 can include a coil coupled to the rechargeable battery to allow the battery to be inductively charged by an external charger.

Expansion module 509 can further include laser pointer 519 for emitting a low-powered beam of visible light. In some examples, laser pointer 519 can include a colored laser diode having any desired color. However, any known laser technology can be used. Laser pointer 519 can be coupled to and be powered by power supply 517. Expansion module 509 can further include a push-button, switch, or other input device to allow the user to selectively control laser pointer 519.

In some examples, expansion module 509 can be attached to base module 201 when the modular stylus 200 is to be used for a presentation. Providing modular stylus 200 with a laser pointer advantageously allows a user to enter inputs into a touch sensitive device, such as a tablet computer or touchpad, and point to an image being displayed overhead using the same device.

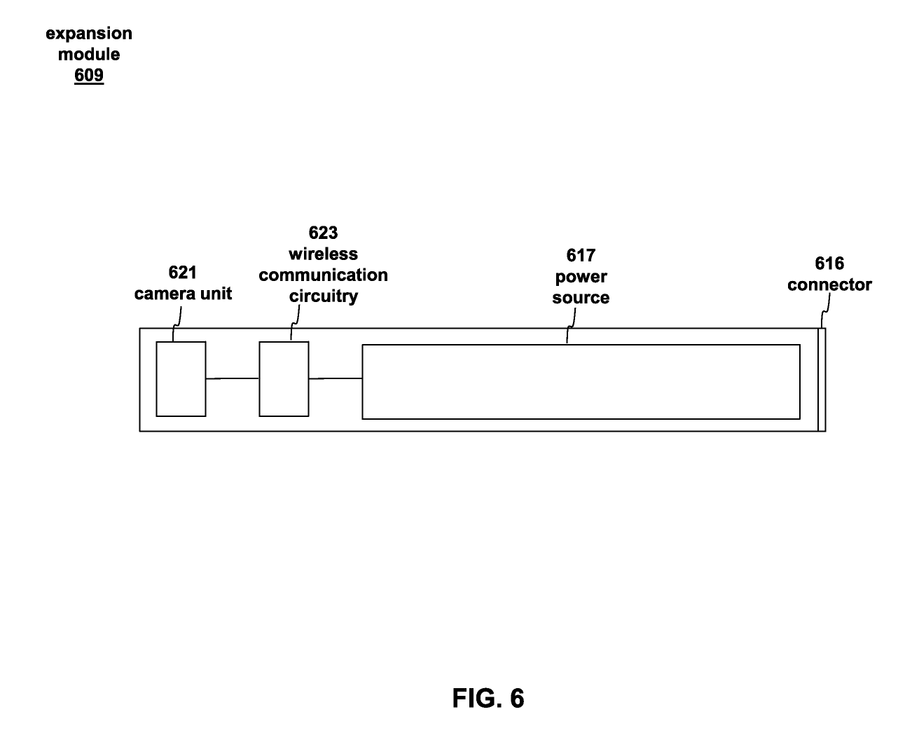

FIG. 6 illustrates a block diagram of another exemplary expansion module 609 for providing a camera functionality that can be used as an expansion module 209 of modular stylus 200. Expansion module 609 can include a connector 616 similar or identical to connector 516 for connecting expansion module 609 to a base module, such as base module 201 or 301. Expansion module 609 can further include power source 617 similar or identical to power source 517 for providing power to the components within expansion module 609 and/or the components within an attached base module. Power can be transferred from power source 617 to an attached base module via connector 616.

Expansion module 609 can further include camera unit 621 for taking and storing pictures. Camera unit 621 can include any type of image sensor, such as a CMOS image sensor for capturing an image. Camera unit 621 can be used to capture still images or record video. Camera unit 621 may further include a storage device, such as a solid state storage device, for storing the images produced by the image sensor. In some examples, camera unit 621 can include a processor for processing the image(s) captured by the image sensor. In other examples, the processor of the base module can be used to process the image data. Camera unit 621 can further include a flash, zoom optics, or the like. Expansion module 609 can further include a push button or other input device to allow the user to take a picture using camera unit 621.

Expansion module 609 can further include wireless communication circuitry 623 coupled to power source 617 and camera unit 621. Wireless communication circuitry 623 can include circuitry to support any known wireless communication technology, such as Bluetooth, Wi-Fi, 3G and 4G cellular technologies, and the like. Wireless communication circuitry 623 can be used to transmit image data from camera unit 621 to a remote computing device, such as a desktop, laptop, tablet, or the like. Wireless communication circuitry 623 can also be used to receive control signals from the remote computing device. For example, commands can be sent from the remote computing device to initiate sending or deleting of the data stored in camera unit 621.

While FIG. 6 shows camera unit 621 being directly coupled to wireless communication circuitry 623 and wireless communication circuitry 623 being directly coupled to power source 617, it should be appreciated that FIG. 6 is a functional block diagram of the system. In an actual implementation, any of the components can be directly or indirectly coupled depending on the design choice. For example, power source 617 can be directly coupled to both camera unit 621 and wireless communication circuitry 623.

Attaching expansion module 609 to base module 201 advantageously allows a user to take pictures (e.g., of a document) and enter inputs into a touch sensitive device, such as a tablet computer, using the same device.

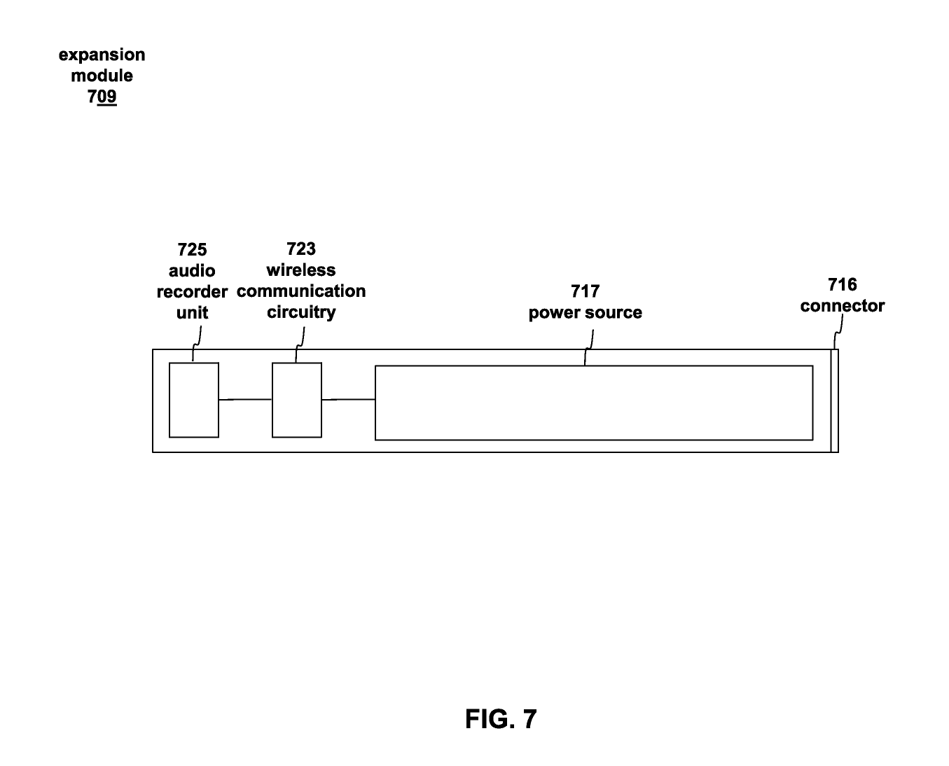

FIG. 7 illustrates a block diagram of another exemplary expansion module 709 for providing audio recording functionality that can be used as expansion module 209 of modular stylus 200. Expansion module 709 can include similar components as expansion module 609, except that camera unit 621 can be replaced with audio recorder unit 725. For example, expansion module 709 can include connector 716 similar or identical to connector 616, power source 717 similar or identical to power source 617, and wireless communication circuitry 723 similar or identical to wireless communication circuitry 623.

Expansion module 709 can include audio recorder unit 725 for recording and storing audio data. Audio recorder unit 725 can include any type of audio recorder, such as a digital audio recorder. Audio recorder unit 725 can further include a storage device, such as a solid state storage device, for storing the audio recordings produced by the audio recorder. In some examples, audio recorder unit 725 can include a processor for processing the audio data generated by the audio recorder. In other examples, the processor of the base module can be used to process the audio data. Audio recorder unit 725 can further include a speaker for playing back the recorded audio data. Expansion module 709 can further include one or more push buttons, switches, or other input devices to allow the user to do one or more of record, stop, play, fast forward, and rewind.

Similar to expansion module 609, expansion module 709 can use wireless communication circuitry 723 to transmit audio data from audio recorder unit 725 to a remote computing device, such as a desktop, laptop, tablet, or the like. In some examples, wireless communication circuitry 723 can also be used to receive control signals from the remote computing device. For example, commands can be sent from the remote computing device to initiate the sending or deleting of data stored in audio recorder unit 725.

While FIG. 7 shows audio recorder unit 725 being directly coupled to wireless communication circuitry 723 and wireless communication circuitry 723 being directly coupled to power source 717, it should be appreciated that FIG. 7 is a functional block diagram of the system. In an actual implementation, any of the components can be directly or indirectly coupled depending on the design choice. For example, power source 717 can be directly coupled to both audio recorder unit 725 and wireless communication circuitry 723.

Attaching expansion module 709 to base module 201 advantageously allows a user to make audio recordings (e.g., of a meeting or oral notes) and enter inputs into a touch sensitive device, such as a tablet computer, using the same device.

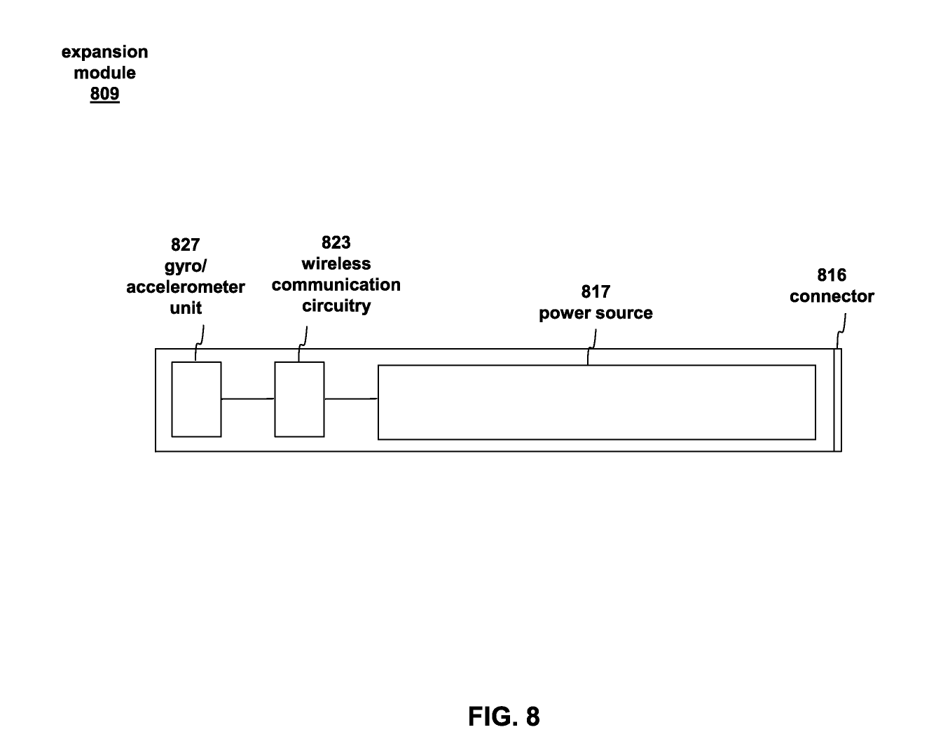

FIG. 8 illustrates a block diagram of another exemplary expansion module 809 for providing improved touch detection and gesture input functionality that can be used as expansion module 209 of modular stylus 200. Expansion module 809 can include similar components as expansion module 609, except that camera unit 621 can be replaced with gyro/accelerometer unit 827. For example, expansion module 809 can include connector 816 similar or identical to connector 616, power source 817 similar or identical to power source 617, and wireless communication circuitry 823 similar or identical to wireless communication circuitry 623.

Expansion module 809 can include gyro/accelerometer unit 827 for detecting movement and orientation of the modular stylus. Gyro/accelerometer unit 827 can include any suitable type of gyroscope and/or accelerometer, such as a micro-electro-mechanical system (MEMS) gyroscope and/or accelerometer. In some examples, gyro/accelerometer unit 827 can include a processor for processing the measurements captured by the gyroscope and/or accelerometer. In other examples, the processor of the base module can be used to process the gyroscope and/or accelerometer data.

Similar to expansion module 609, expansion module 809 can use wireless communication circuitry 823 to transmit gyroscope and/or accelerometer data from gyro/accelerometer unit 827 to a remote computing device, such as a desktop, laptop, tablet, or the like. In some examples, the gyroscope and/or accelerometer data can be wirelessly transmitted to the touch sensitive device that is being used with modular stylus 200. In this example, the gyroscope and/or accelerometer data can be used to supplement the position data of the stylus tip determined by the touch sensitive device. For example, in a drawing application, the tilt of the stylus can be used to adjust the shape and thickness of lines made by the stylus to more closely mimic that of an actual pen or paintbrush. In another example, motion detected by gyroscope and/or accelerometer data can be used to allow gesture input. For example, a sweeping motion of the stylus can be detected by gyro/accelerometer unit 827 and transmitted to a remote computing device, such as the touch sensitive device, and can be interpreted by the remote computing device as a type of input (e.g., as a command to turn a page in an electronic book, to transition to the next or previous slide in a presentation, or to move a cursor). In this way, the stylus can be used as a mouse replacement, for example, in slide presentations.

While FIG. 8 shows gyro/accelerometer unit 827 being directly coupled to wireless communication circuitry 823 and wireless communication circuitry 823 being directly coupled to power source 817, it should be appreciated that FIG. 8 is a functional block diagram of the system. In an actual implementation, any of the components can be directly or indirectly coupled depending on the design choice. For example, power source 817 can be directly coupled to both gyro/accelerometer unit 827 and wireless communication circuitry 823.

Attaching expansion module 809 to base module 201 advantageously provides improved touch detection and gesture input functionality to the modular stylus.

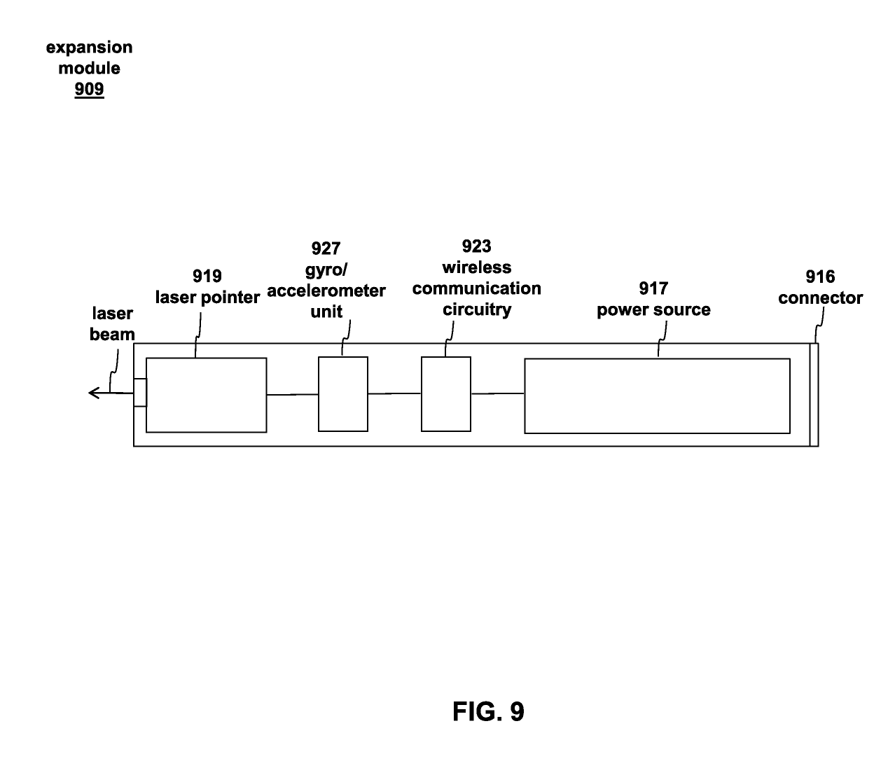

FIG. 9 illustrates a block diagram of yet another variation of another exemplary expansion module 909 that can be used as an expansion module 209 of modular stylus 200. Expansion module 909 is similar to expansion module 809, but further provides for laser pointer functionality. For example, expansion module 909 can include connector 916 similar or identical to connector 816, power source 917 similar or identical to power source 817, wireless communication circuitry 923 similar or identical to wireless communication circuitry 823, and gyro/accelerometer unit 927 similar or identical to gyro/accelerometer unit 827. Expansion module 909 can further include laser pointer 919 similar or identical to laser pointer 519 of expansion module 509. Expansion module 909 can further include a push-button, switch, or other input device to allow the user to selectively control laser pointer 919.

While FIG. 9 shows laser pointer 919 being directly coupled to gyro/accelerometer unit 927, gyro/accelerometer unit 927 being directly coupled to wireless communication circuitry 923, and wireless communication circuitry 923 being directly coupled to power source 917, it should be appreciated that FIG. 9 is a functional block diagram of the system. In an actual implementation, any of the components can be directly or indirectly coupled depending on the design choice. For example, power source 917 can be directly coupled to laser pointer 919, gyro/accelerometer unit 927, and wireless communication circuitry 923.

Attaching expansion module 909 to base module 201 advantageously provides improved touch detection and gesture input functionality to the modular stylus as well as allows for a user to enter inputs into a touch sensitive device, such as a tablet computer or touchpad, and point to an image being displayed overhead using the same device.

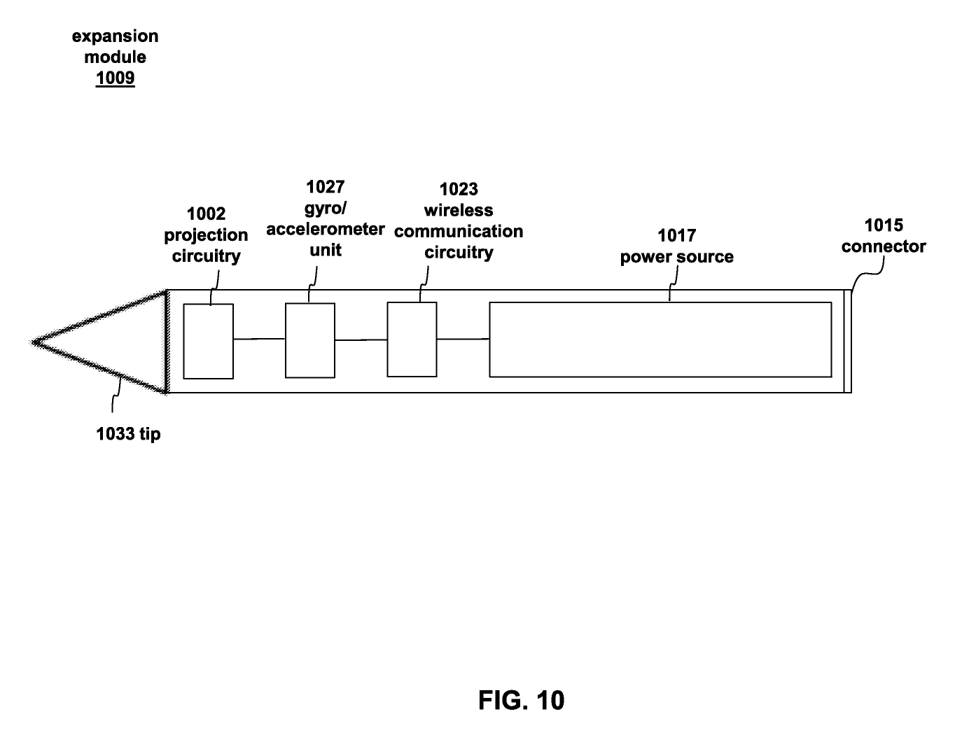

FIG. 10 illustrates a block diagram of another exemplary expansion module 1009 for providing image projection functionality that can be used as expansion module 209 of modular stylus 200. Expansion module 1009 can include similar components as expansion module 909, except that laser pointer 919 can be replaced with projection circuitry 1002 and that expansion module 909 can further include tip 1033. For example, expansion module 1009 can include connector 1016 similar or identical to connector 916, power source 1017 similar or identical to power source 917, wireless communication circuitry 1023 similar or identical to wireless communication circuitry 923, and gyro/accelerometer unit 1027 similar or identical to gyro/accelerometer unit 927.

Expansion module 1009 can include projection circuitry 1002 for projecting an image toward a surface through a transparent lens and tip assembly 1033 or process an image projected from the surface through lens and tip assembly 1033 to projection circuitry 1002. Projection circuitry 1002 can include a light-source (e.g., laser, LED, digital light processing (DLP) projector, LCD projector, or the like), liquid crystal module (LCM) to modulate the light according to image data, suitable control electronics for the LCM and LED driver, and a processor. Alternatively, the processor located in an attached base module can be used for this function. Projection circuitry 1002 can further include a storage device, such as a solid state storage device, for storing images or video to be displayed by projection circuitry 1002. Projection circuitry 1002 can further include imaging circuitry, such as a charge-coupled device (CCD), coupled to the processor through suitable control and signal conditioning electronics.

While FIG. 10 shows projection circuitry 1002 directly coupled to gyro/accelerometer unit 1027, gyro/accelerometer unit 1027 being directly coupled to wireless communication circuitry 1023, and wireless communication circuitry 1023 being directly coupled to power source 1017, it should be appreciated that FIG. 10 is a functional block diagram of the system. In an actual implementation, any of the components can be directly or indirectly coupled depending on the design choice. For example, power source 1017 can be directly coupled to projection circuitry 1002, gyro/accelerometer unit 1027, and wireless communication circuitry 1023, projection circuitry 1002.

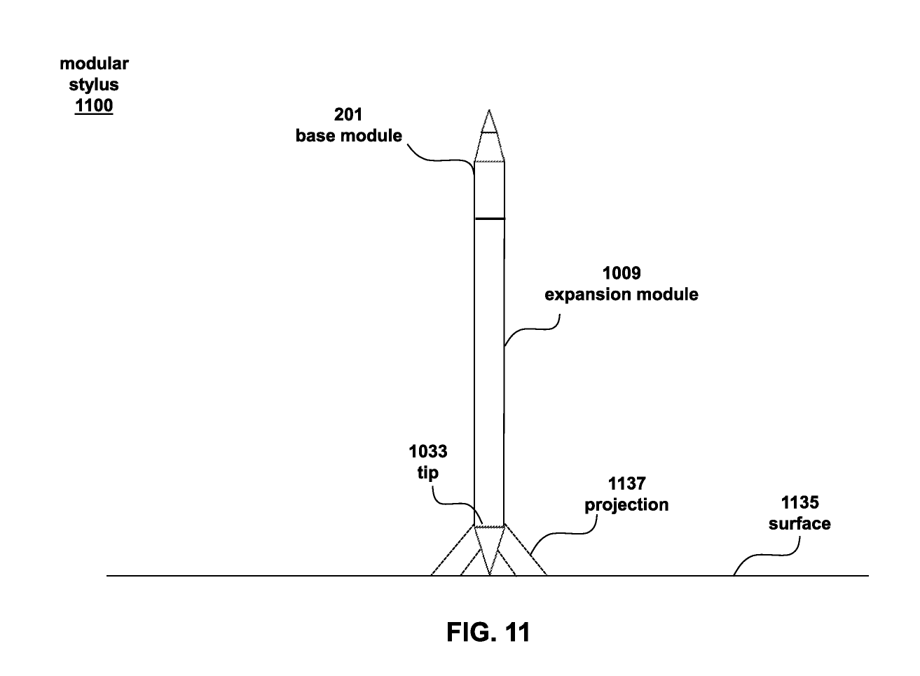

FIG. 11 illustrates one example use of expansion module 1009. In this example, expansion module 1009 can be used to display and edit a document, such as a text document or image. The document can be stored in the storage device of projection circuitry 1002 and the processor located in projection circuitry 1002 (or alternatively in an attached base module) can cause the projector of projection circuitry 1002 to display the stored document. The projection 1137 can be displayed on surface 1135, such as a table surface. In some examples, a user can place tip 1033 of expansion module 1009 in contact with surface 1135 and move modular stylus 1100 across surface 1135 to draw or write on the displayed document. The contact between tip 1033 and surface 1135 can be detected using a pressure sensor or similar device located in expansion module 1009. The movement of modular stylus 1100 can be detected by gyro/accelerometer unit 1027 and the detected movement can be transmitted to projection circuitry 1002 (or alternatively to the processor located in an attached base module). In response to the detected movement, projection circuitry 1002 can cause the projector of projection circuitry 1002 to adjust projection 1137 such that the placement of projection 1137 on surface 1135 remains at least substantially in place relative to surface 1135. In this way, a user can draw or write on projection 1137 without moving projection 1137. Additionally, a user can lift modular stylus 1100 from surface 1135 to move to another portion of projection 1137. The vertical and lateral movement can be detected by gyro/accelerometer 1027 and transmitted to projection circuitry 1002. Projection circuitry 1002 can then cause the projector of projection circuitry 1002 to adjust projection 1137 such that the placement of projection 1137 remains at least substantially in place surface 1135. Additionally, projection 1137 can be scaled to adjust for the change in height relative to surface 1135. For example, projection 1137 can be scaled smaller as modular stylus 1100 is raised from surface 1135 to compensate for the increased distance between the projector of projection circuitry 1002 and surface 1135. Similarly, projection 1137 can be scaled larger as modular stylus 1100 is lowered towards surface 1135 to compensate for the decreased distance between the projector of projection circuitry 1002 and surface 1135. The relative position of modular stylus 1100 can also be determined using an imager, which can be added to projection circuitry 1002 to image surface 1135 and determine relative movement through correlation techniques, such as those used in optical engines for optical mice.

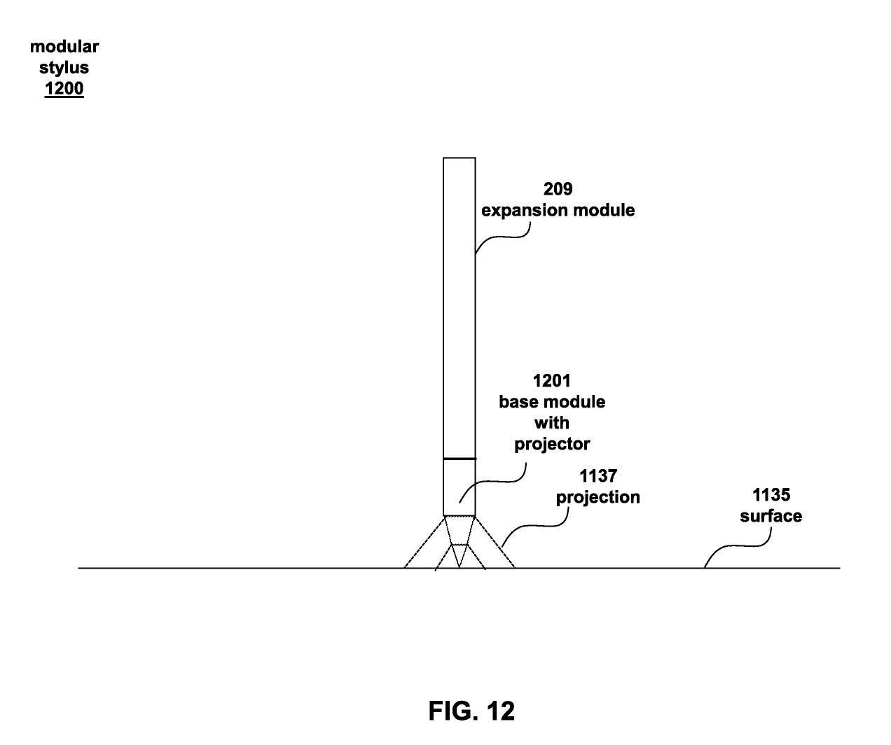

FIG. 12 illustrates an exemplary modular stylus 1200 similar to that shown in FIG. 11, except that the projection functionality is included within base module 1201 rather than expansion module 209. For example, base module 1201 can be similar or identical to base module 401, described above.

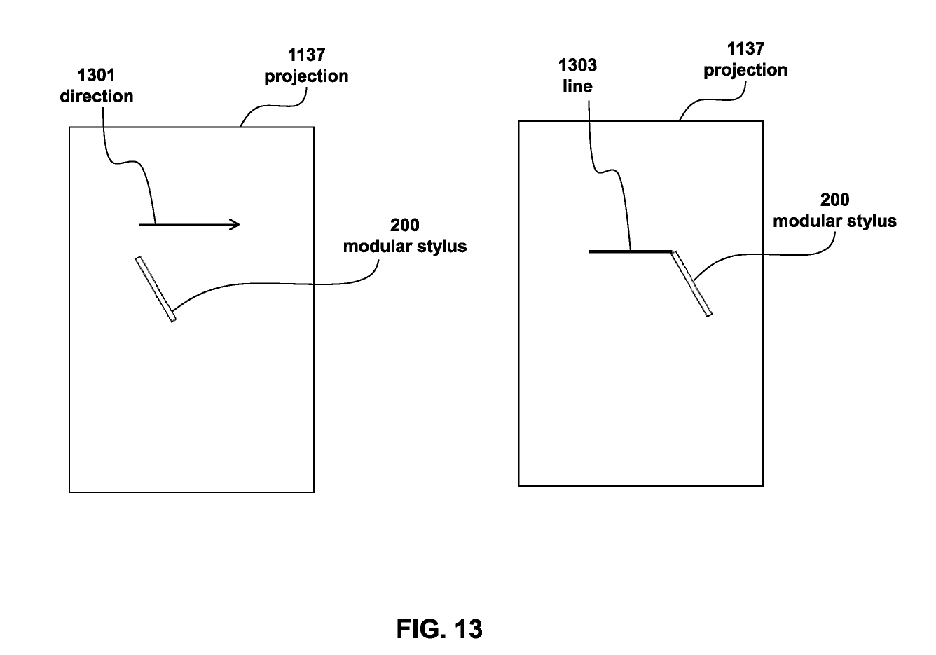

To further illustrate the operation of modular styluses 1100 and 1200, FIG. 13 shows modular stylus 1100/1200 generating image projection 1137 on surface 1135 (not shown). In the image shown on the left side of FIG. 13, tip 1033/307 of modular stylus 1100/1200 is placed on surface 1135 and begins moving in direction 1301. The motion can be detected by gyro/accelerometer unit 1027 and transmitted to projection circuitry 1002. In response to receiving the detected motion, projection circuitry 1002 can adjust the image displayed by the projector of projection circuitry 1002 such that projection 1137 remains at least substantially in place relative to surface 1135. Additionally, since tip 1033/307 is in contact with surface 1135, line 1303 is “drawn” on the document represented by projection 1137 and displayed by the projector of projection circuitry 1002. Had tip 1033/307 not been in contact with surface 1135, projection 1137 would have been adjusted in the same manner, but line 1303 would not have been displayed.

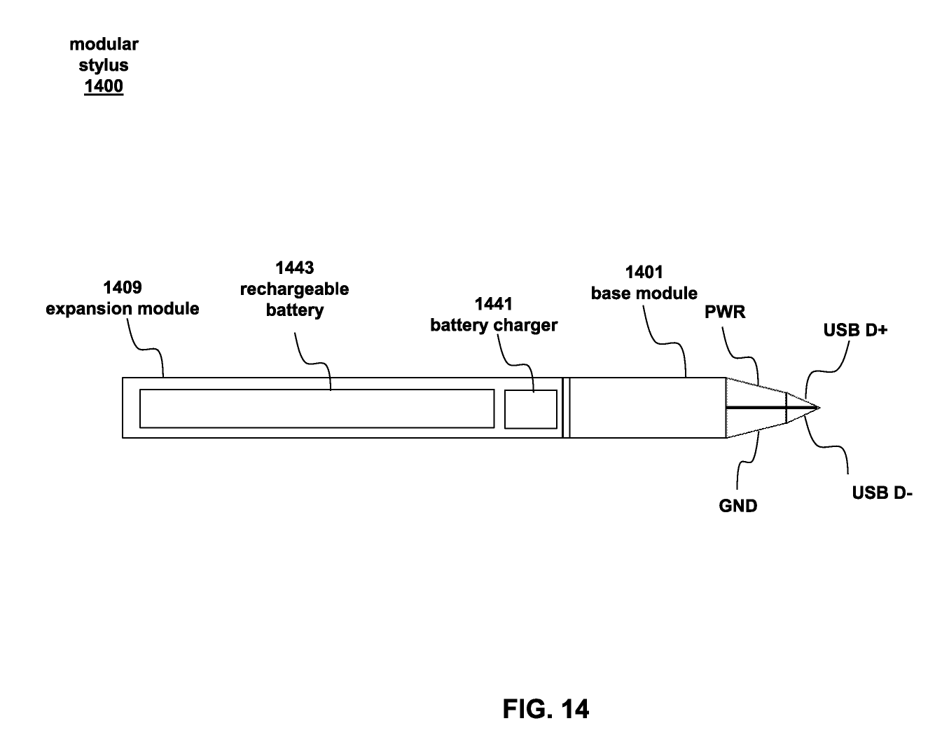

FIG. 14 illustrates an exemplary modular stylus 1400 having components to enable wired data communication through a segmented tip and ring connection, without requiring separate connectors. Modular stylus 1400 includes base module 1401 and expansion module 1409. In this embodiment, a data connection (e.g., USB) can be established through the tip of base module 1401 having a first and a second segment with connections to USB D+ and USB D−. Similarly, a power connection can be facilitated through the ring assembly of base module 1401 having a first and a second segment for power and ground connections. In this way, a wired data/power connection can be facilitated through a stylus cradle assembly having suitable contacts. Expansion module 1409 can include battery charger 1441 operable to condition the power supplied to the stylus for charging rechargeable battery 1443 (e.g., an alkaline battery, zinc-carbon battery, or the like).

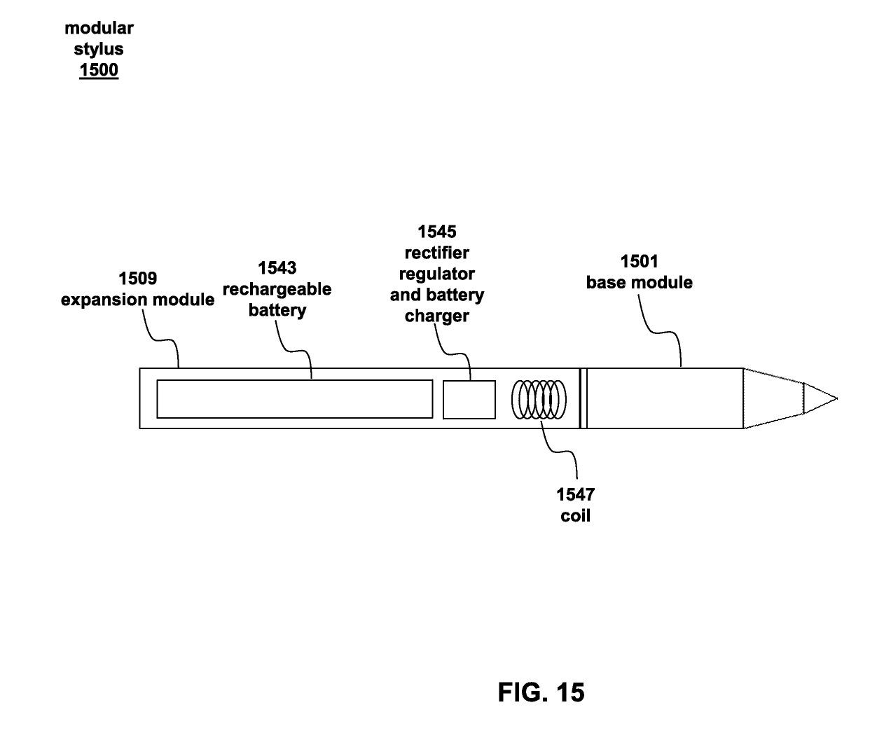

FIG. 15 illustrates another exemplary modular stylus 1500 having components to enable wireless charging. Modular stylus 1500 includes a base module 1501 similar or identical to base module 201 or 301 and an expansion module 1509. In this embodiment, expansion module 1509 can include a coil 1547 and other suitable circuitry (e.g. rectifier, regulator, and battery charger 1545) to condition an AC signal received from coil 1547 for charging rechargeable battery 1543 (e.g., an alkaline battery, zinc-carbon battery, or the like). Modular stylus 1500 can be coupled to a stylus cradle having a coil and drive electronics to facilitate energy transfer to coil 1547 via an inductive coupling between the coil of the stylus cradle and coil 1547.

While the examples shown in FIGS. 5-15 show expansion modules and base modules having various components, such as a laser pointer, power source, gyro/accelerometer unit, wireless communication circuitry, projection circuitry, audio recorder unit, a camera unit, and battery charging circuitry, it should be appreciated that expansion modules and base modules having any combination of these features can be used. For example, an expansion module can include both a camera unit and an audio recorder unit to capture both video and sound.

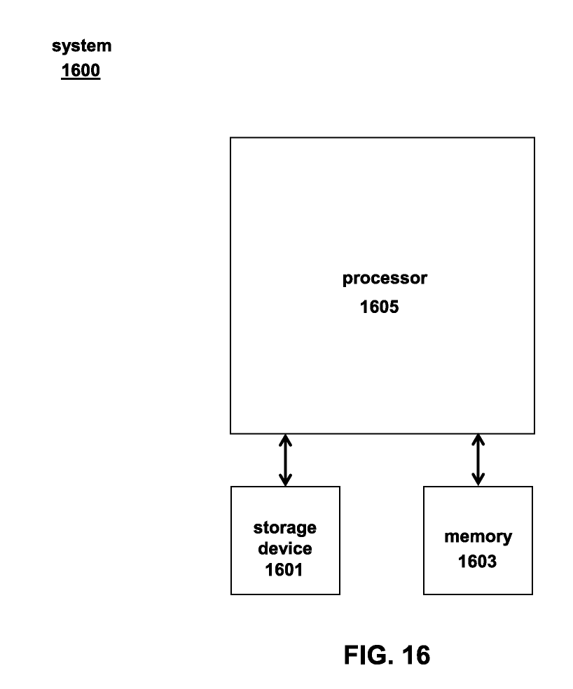

One or more of the functions relating to the operation of a modular stylus described above can be performed by a system similar or identical to system 1600 shown in FIG. 16. System 1600 can include instructions stored in a non-transitory computer readable storage medium, such as memory 1603 or storage device 1601, and executed by processor 1605. The instructions can also be stored and/or transported within any non-transitory computer readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer readable storage medium” can be any medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The instructions can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

It is to be understood that the system is not limited to the components and configuration of FIG. 16, but can include other or additional components in multiple configurations according to various embodiments. Additionally, the components of system 1600 can be included within a single device, or can be distributed between multiple devices.

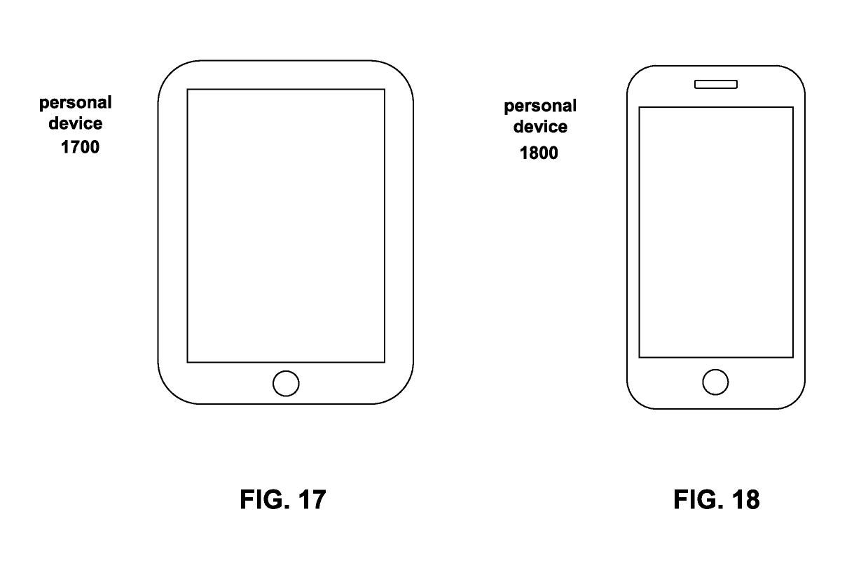

FIG. 17 illustrates an exemplary personal device 1700, such as a tablet, that can be used with a modular stylus according to various embodiments.

FIG. 18 illustrates another exemplary personal device 1800, such as a mobile phone, that can be used with a modular stylus according to various embodiments.

Although embodiments have been fully described with reference to the accompanying drawings, it is to be noted that various changes and modifications will become apparent to those skilled in the art. Such changes and modifications are to be understood as being included within the scope of the various embodiments as defined by the appended claims.

What is claimed is:

1. A modular stylus comprising:
an expansion module comprising:
a communication circuit capable of communicating with a remote device; and
a first connection interface; and
a base module comprising:
a stylus tip capable of interacting with a touch sensitive device;
a stylus stimulation signal circuit coupled to the stylus tip, the stylus stimulation signal circuit capable of outputting a stylus stimulation signal through the stylus tip, wherein the stylus stimulation signal is capable of being received by a touch sensor of the touch sensitive device;
a processor capable of controlling the stylus stimulation signal circuit; and
a second connection interface capable of being selectively coupled with the first connection interface of the expansion module.

2. The modular stylus of claim 1, wherein the communication circuit comprises a wireless communication circuit capable of wirelessly communicating with the remote device.

3. The modular stylus of claim 1, wherein the expansion module further comprises a camera or an audio recorder.

4. The modular stylus of claim 1, wherein the expansion module further comprises a gyroscope or accelerometer.

5. The modular stylus of claim 4, wherein the remote device is the touch sensitive device, and wherein the communication circuit is capable of transmitting movement data received from the gyroscope or accelerometer to the touch sensitive device.

6. The modular stylus of claim 1, wherein the expansion module further comprises a power source capable of powering the stylus stimulation signal circuit and the processor.

7. A modular stylus comprising:
an expansion module comprising:
a power source; and
a first connection interface; and
a base module comprising:
a stylus tip capable of interacting with a touch sensitive device;
a stylus stimulation signal circuit coupled to the stylus tip, the stylus stimulation signal circuit capable of outputting a stylus stimulation signal through the stylus tip, wherein the stylus stimulation signal circuit is capable of being powered by the power source; and
a second connection interface capable of being coupled with the first connection interface of the expansion module.

8. The modular stylus of claim 7, wherein the stylus stimulation signal is capable of being received by a touch sensor of the touch sensitive device.

9. The modular stylus of claim 7, wherein the power source comprises an inductive coil capable of wirelessly charging a battery of the power source.

10. The modular stylus of claim 7, wherein the expansion module further comprises a laser pointer, the laser pointer capable of being powered by the power source.

11. The modular stylus of claim 7, wherein the expansion module further comprises one or more of a camera, an audio recorder, a communication circuit, gyroscope, accelerometer, laser pointer, and a projector.

12. The modular stylus of claim 7, wherein the base module further comprises a processor capable of controlling the stylus stimulation signal circuit.

13. A modular stylus comprising:
an expansion module comprising:
a power source;
a memory coupled to receive power from the power source;
a projector coupled to receive power from the power source, wherein the projector is capable of projecting an image stored in the memory;
a transparent tip assembly comprising a lens capable of expanding the image from the projector;
a processor coupled to receive power from the power source, wherein the processor is capable of controlling the projector; and
a first connection interface; and
a base module comprising:
a stylus tip capable of interacting with a touch sensitive device; and
a second connection interface capable of being coupled with the first connection interface of the expansion module.

14. The modular stylus of claim 13, wherein the expansion module further comprises a gyroscope or an accelerometer capable of detecting motion of the expansion module.

15. The modular stylus of claim 14, wherein in response to a detection of motion by the gyroscope or the accelerometer, the processor is capable of causing a change in the projected image corresponding to the detected motion.

16. The modular stylus of claim 15, wherein the image is capable of being projected onto a surface, and wherein in response to movement of the stylus tip across the image projected on the surface the processor is capable of causing the projector to project a visual indicator on the image corresponding to the movement of the stylus tip across the image projected on the surface.

17. A stylus base module comprising:
a stylus tip capable of interacting with a touch sensitive device;
a stylus stimulation signal circuit coupled to the stylus tip, the stylus stimulation signal circuit capable of outputting a stylus stimulation signal through the stylus tip, wherein the stylus stimulation signal circuit is capable of being powered by the power source; and
a connection interface capable of selectively connecting the base module to a stylus expansion module.

18. The stylus base module of claim 17, wherein the connection interface is further capable of transferring power from a power source located in a connected stylus expansion module to the stylus stimulation signal circuit.

19. The stylus base module of claim 17 further comprising a processor capable of controlling the stylus stimulation signal circuit.

20. The stylus base module of claim 17, wherein the stylus tip comprises a transparent material coated with indium tin oxide, and wherein the stylus base further comprises:
a projector capable of projecting an image; and
a lens capable of expanding the image from the projector.

21. The stylus base module of claim 17, wherein the stylus tip comprises a transparent material coated with indium tin oxide, and wherein the stylus base further comprises imaging circuitry capable of imaging an image received through the stylus tip.

22. A stylus expansion module comprising:
a power source;
a communication circuit coupled to receive power from the power source, wherein the communication circuit is capable of communicating with a remote device; and
a connection interface configured to selectively connect the stylus expansion module to a stylus base module.

23. The stylus expansion module of claim 22 further comprising a camera or an audio recorder.

24. The stylus expansion module of claim 23, wherein the communication circuit is capable of transmitting image or audio data received from the camera or audio recorder to the remote device.

25. The stylus expansion module of claim 22, wherein the expansion module further comprises a gyroscope or accelerometer, and wherein the communication circuit is capable of transmitting movement data received from the gyroscope or accelerometer to the remote device.
